(19) United States
(12) Patent Application Publication
(10) Pub. No.: US 2015/0371267 A1
(43) Pub. Date: Dec. 24, 2015

(54) SYSTEMS AND METHODS FOR ADVERTISEMENT FILTERING

(71) Applicant: Shine Security Ltd., Herzlia Pituach (IL)

(72) Inventors: Ron PORAT, RaAnana (IL); Oren FARAGE, Ramat-Gan (IL); Ianir IDESES, RaAnana (IL); Itay KATZ, RaAnana (IL); Doron SHAMIA SADEH, Givataim (IL)

(21) Appl. No.: 14/745,507

(22) Filed: Jun. 22, 2015

Related U.S. Application Data
(60) Provisional application No. 62/015,533, filed on Jun. 23, 2014.

(51) Int. Cl. G06Q 30/02

(52) U.S. Cl. CPC G06Q 30/0257; G06Q 30/0269

(57) ABSTRACT

There is provided a computer-implemented method for filtering advertisements transmitted through a network to a client, comprising: receiving at a client, from a user of the client, a user preference for filtering of advertisements for display on the client, the advertisements being transmitted over a network from an ad server to the client; transmitting the user preference from the client to a network element located at an intermediate transmission location within the network between the ad server and the client; and filtering the transmitted advertisements at the network element to block or allow advertisements to transmit to the client based on the user preference.

### RELATED APPLICATION

This application claims the benefit of priority under 35 USC 119(e) of U.S. Provisional Patent Application No. 62/015,533 filed on Jun. 23, 2014, the contents of which are incorporated herein by reference in their entirety.

### BACKGROUND

The present invention, in some embodiments thereof, relates to methods and systems for control of internet advertising and, more specifically, but not exclusively, to methods and systems for blocking advertising to mobile clients.

### SUMMARY

According to an aspect of some embodiments of the present invention there is provided a computer-implemented method for filtering advertisements transmitted through a network to a client, comprising: receiving at a client, from a user of the client, a user preference for filtering of advertisements for display on the client, the advertisements being transmitted over a network from an ad server to the client; transmitting the user preference from the client to a network element located at an intermediate transmission location within the network between the ad server and the client; and filtering the transmitted advertisements at the network element to block or allow advertisements to transmit to the client based on the user preference.

Optionally, the network element is selectively positioned within the network to increase bandwidth within the network based on the blocking of the filtered advertisements.

Optionally, the user preference comprises a user profile denoting at least one of advertisement categories to block and advertisement categories to allow.

Optionally, the filtering is performed based on deep packet inspection methods applied to packets transmitted to the client to identify the advertisements.

Optionally, the method further comprises: collecting data from the client; processing the data to identify at least one advertisement category; wherein receiving comprises receiving from the user at the client, a user profile denoting at least one of identified advertisement categories to block and identified advertisement categories to allow; wherein filtering comprises filtering the advertisements to enable pass-through or block specific targeted ads associated with respective the at least one advertisement category based on the user profile. Optionally, processing the data to identify at least one advertising category comprises applying at least one classifier to the collected data to automatically identify the at least one advertising category for blocking or allowing advertisements categorized under the at least one advertising category.

Optionally, the data comprises at least one member selected from a group consisting of: applications installed on the client, usage pattern of installed applications, geographical locations of the client, and internet browsing history.

Optionally, filtering comprises at least one of filtering advertisements transmitted from the ad server to the client, and filtering polling signals transmitted from advertising applications installed on the client to the ad server.

Optionally, filtering by the network element at the network level is performed with explicit consent of the user.

Optionally, the method further comprises verifying the filtering is performed based on the user preference by monitoring actual advertisements received at the client relative to the user preference.

According to an aspect of some embodiments of the present invention there is provided a system for filtering advertisements transmitted through a network to a client, comprising: a user interface module for installation on a client, the user interface module programmed to receive from a user, a user preference for filtering of advertisements for display on the client, the advertisements being transmitted over a network from an ad server to the client; and a network element located at an intermediate transmission location within the network between the ad server and the client, the network element programmed to receive the user preference from the client, and filter the transmitted advertisements based on the received user preference to block or allow the advertisements being transmitted to the client.

Optionally, the network element is selectively positioned within the network to increase bandwidth within the network based on the blocking of the filtered advertisements.

Optionally, the client is a mobile device having a wireless interface for wireless communication with the network, and the filtering reduces advertisement related radio signaling by the mobile device.

Optionally, the system further comprises a data collection module for installation on the client, the data collection modules collects data denoting at least one user interest and transmits at least one of the collected data and the at least one user interest to the network element for filtering the advertisements based on the at least one user interest, to enable pass-through of specific targeted ads associated with the at least one user interest to the client.

Optionally, the user interface is programmed to comprise at least one member selected from a group consisting of: selection of whether to globally receive advertisements or not, selection of specific ad categories to block, selection of specific ad categories to allow, selection of data to be used to build automatic category selection lists, and selection of whether or not to allow transmission of the selected ad categories to the network element for targeted filtering.

Optionally, the system further comprises a client filtering module for installation on the client, the client filtering module selectively blocking advertisement related traffic from the client to the ad server based on the user preference.

Optionally, the system further comprises an ad detection module for installation on the client, the ad detection module monitors actual ads received by the client to verify that the filtering complies with the user preference. Optionally, the system further comprises a tamper detection module for installation on the client, the tamper detection module detects client or network tampering by unwanted ads based on monitoring of improperly received ads.

Optionally, the system further comprises a data analysis module for installation on the client, the data analysis module automatically generates a category list based on data derived from the client for advertisement blocking or allowing.

According to an aspect of some embodiments of the present invention there is provided a computerized method for filtering advertisements transmitted through a network to a client, comprising, comprising: receiving multiple user preferences, each user preference received from each of multiple common users, the user preferences received through multiple user interfaces which are installed on multiple remote clients, each respective user preference denotes filtering of advertisements for display on the respective client, the advertisements being transmitted over a network from at least one ad server to each respective client; transmitting the multiple user preferences to at least one central server located at an intermediate transmission location within the network between the at least one ad server and each client; and filtering each transmitted advertisement destined for each respective common user, at the central server, to block or allow each respective advertisement to each respective remote client based on respective user preference of each respective common user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a high level flowchart of an exemplary method for filtering advertisements transmitted to a client, in accordance with some embodiments of the present invention;

FIG. 2 is a block diagram of an exemplary system for filtering advertisements transmitted to a client, in accordance with some embodiments of the present invention;

FIG. 3 is a detailed flowchart of an exemplary method for filtering advertisements transmitted to a client, based on the flowchart of FIG. 1, in accordance with some embodiments of the present invention; and

FIG. 4 is a schematic diagram of an exemplar user interface application executed on the client to control filtering of advertisements to the client, in accordance with some embodiments of the present invention.

### DETAILED DESCRIPTION

The present invention, in some embodiments thereof, relates to methods and systems for control of internet advertising and, more specifically, but not exclusively, to methods and systems for blocking advertising to mobile clients.

An aspect of some embodiments of the present invention relates to systems and/or methods for filtering, at the network level, advertisements transmitted through a network to one or more clients, based on user preferences provided by each respective user of each client. Based on the user preferences, the filtering blocks advertisements from reaching the client, or allows certain advertisements to continue transmission to the client. Advertisements may be transmitted by one or more ad servers connected to the network. Clients may be mobile devices having wireless network connectivity, such as Smartphones, Tablet computers, laptop computers, and the like. The network may include a cellular network.

As used herein, the term ad server sometimes refers to network servers that are used primarily for ad serving (such as in response to a message from a client terminal and/or a client server), and/or servers that serve ads as an embedded and/or integral part of the content data, for example, as part of an interactive network document such as a webpage.

The location of the advertisement filtering within the network may be selected based on the expected increase in available network bandwidth and/or decrease in advertisement traffic when advertisements are selectively blocked. In this manner, blocking of advertisements based on the user preferences increases overall network performance.

Blocking of advertisements to the client at the network level is based on permission explicitly provided by the user of the client. Permission may be provided from each respective user of each client being serviced by the network. The user may define one or more user preferences that include the permission by a user interface accessed through the client. The user preference may be defined as a user profile that includes types of advertisements to block and/or types of advertisements to allow. For example, advertisements categories that are interesting to the user and have been selected to be allowed to be displayed, and/or other advertisement categories that are not interesting to the user have been selected for blocking.

Optionally, permission obtained from respective users at each of the clients is transmitted to a network element (e.g., central server, router, other network elements with packet filtering abilities) performing the advertisement filtering at the network level. Multiple users accessing remote and/or geographically dispersed clients may transmit their respective user preferences and/or user profiles to the central network element. Filtering methods may be based on deep packet inspection (DPI). DPI methods, which may be resource intensive, may be performed by the network element designed to execute the DPI methods on the network traffic without significantly delaying traffic, for example a DPI enabled router, a DPI enabled central server, or network architecture designed for DPI, such as port mirroring and/or optical splitting.

Users selecting to reduce or block advertisement transmission to their respective clients may have reduced network costs secondary to reduced network bandwidth usage.

Advertisements may be generated and/or transmitted by the ad server in response to adware applications installed on the client device. Optionally, signals generated at the client, such as by the adware applications towards the ad server are filtered. Such unwanted signals may be blocked at the client. The blocking of the adware signals at the client may reduce or prevent undesired radio signaling, such as polling of adware servers by adware applications when the user's mobile device is not being used. Battery life of the mobile device may be increased by the reduction in radio activity. Costs associated with excessive data download may be reduced or prevented.

Optionally, data is automatically collected and processed from the client to automatically identify one or more advertising categories. Data may be obtained, for example, from one or more sources such as: user browsing history, applications installed on the client, usage profiles of the installed applications, and geographical positions of the client. Advertisements falling under the category of one or more of the categories may be allowed to be transmitted to the client. The user may manually select desired categories from the automatically identified categories. The desired categories may be transmitted to the network element for advertisement filtering based on the desired categories. In this manner, users may receive targeted advertisements based on categories that they are interested in, while other advertisements of non-interesting categories are blocked.

Optionally, the actual advertisements received at the client are monitored, to verify compliance with the user preference and/or user profile. Mismatches, such as receipt of improper advertisements and/or non-receipt of desired advertisement categories may be identified and/or auctioned. Tampering may be detected based on the mismatches, for example, malware generating undesired advertisements that have avoided the network element may be detected.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

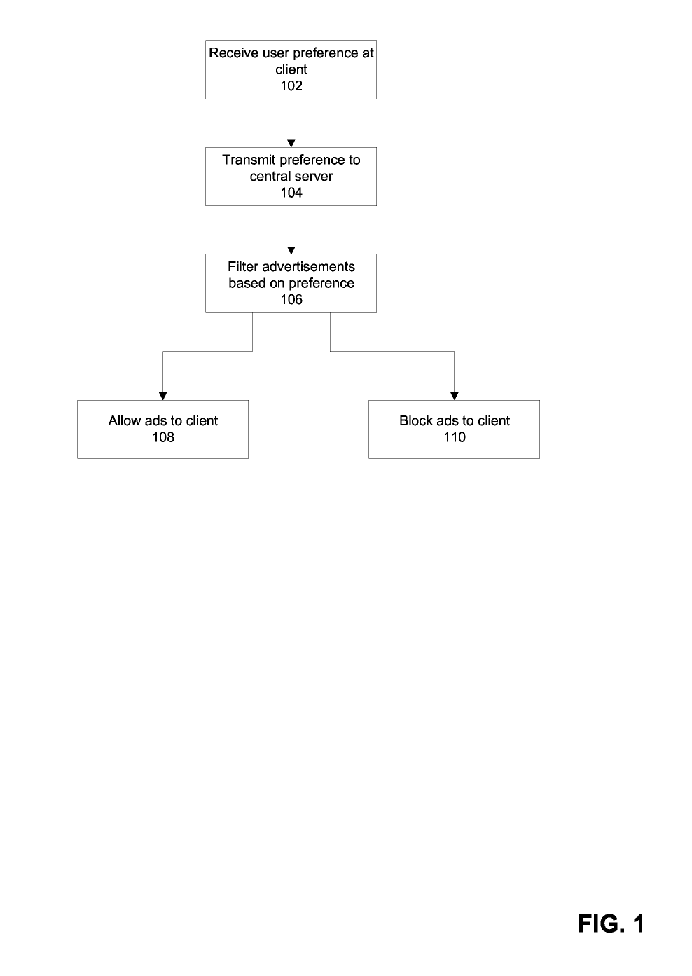

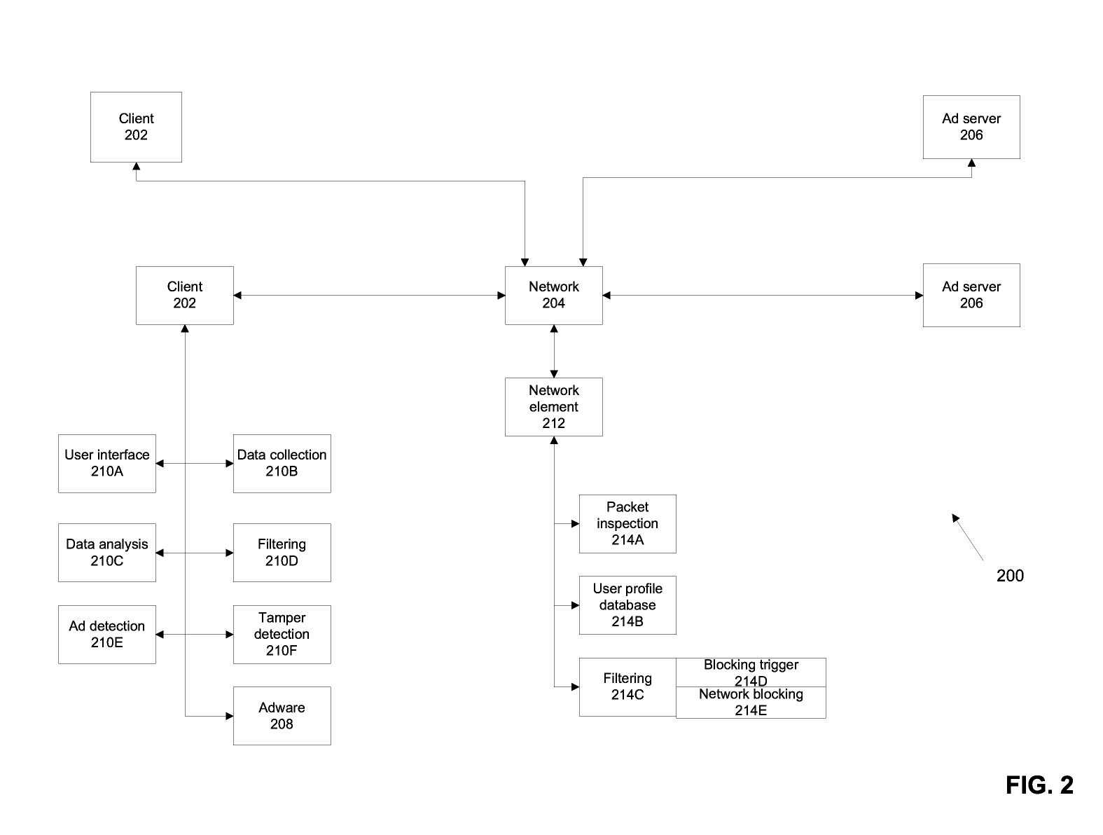

Reference is now made to FIG. 1, which is a simplified flowchart of a computer-implemented method for filtering advertisements sent to a client, the filtering performed at the network level based on client user preferences, in accordance with some embodiments of the present invention. Reference is also made to FIG. 2, which is a block diagram of a system for filtering advertisements sent to a client, the filtering performed at the network level based on client user preferences, in accordance with some embodiments of the present invention. The method of FIG. 1 may be executed by the system of FIG. 2.

System 200 includes one or more clients 202, such as a mobile device, for example, a Smartphone, a Tablet computer, a laptop computer, or other portable devices having wireless network connectivity. Client 202 may be a non-portable device and/or terminal having network connectivity, for example, a desktop computer. Client 202 includes an interface for connection to a network 204 using wireless and/or wired methods. Network 204 is operated by one or more network service providers, for example, a cellular network operator, internet service providers (ISP), and/or telecommunication carriers. One or more ad servers 206 connected to network 204 send advertisements to client(s) 202 via network 204. One or more adware applications 208 (for example, based on the Android® operating system) installed on client 202 may communicate with ad server 206, to request and/or receive advertisements for display on client 202.

A network element 212 connected to network 204 filters advertisements sent by ad server 206 to client 202. Packets may be intercepted and analyzed en-route, for example, based on deep packet inspection methods such as by a packet inspection module 214A for inspection of en-route packets. Network element 212 is, for example, a router having DPI capabilities, a central server, or other network nodes with the resources and/or capability to intercept, analyze and filter packets. Network element 212 may be located at an intermediate transmission location within network 212 between ad server 206 and client 202, such that packets transmitted from ad server 206 to client 202 may be intercepted and filtered by network element 212.

The proliferation of mobile devices such as Smartphones having installed thereon mobile applications (apps) has intensified pressure on mobile network resources. Inventors realized that a source of pressure on the network is the background activity generated by the mobile apps. Even when users are not actively using their phones, mobile apps create background activity that affects network performance. For example, mobile apps frequently check for new content and updates. Every time an application polls a respective ad server to check for an update, the mobile device sets up a data access connection. Establishing the data connection generates signaling activity that can create performance bottlenecks within the network. Applications that receive browser ads and/or in-app advertisements for monetization create excess network traffic. These applications periodically poll ad server(s) for additional advertisements, for example, banners and video advertisements. These ads are then sent over the network and displayed to the user on the client device. These ads may appear in applications that otherwise would require no network activity. In such cases, the mobile phone's radio, instead of switching into idle mode, constantly toggles between idle and connected, causing significant amount of excessive radio signaling. The methods and/or systems described herein reduce or remove the advertisements transmitted to the client through the network, by filtering and optionally blocking the advertisements at the network level based on user defined preferences. In such a manner, network traffic due to undesired advertisements is reduced. Selected ads desired by the user are allowed to continue transmission to the client.

Optionally, at 102, client user preferences are received from the user of the client. The user preferences may be received, for example, by the user accessing a user interface module 210A installed on client 202. Alternatively or additionally, the preferences are received from the client accessing a central server connected to network 204, and/or based on stored predefined user preferences.

The user preference defines filtering of advertisements sent by ad server 206 for display on client 202. For example, to enable receipt of advertisements, or block all advertisements.

Alternatively or additionally, a user profile defines one or more user preferences for ads of different categories, such as different topics and/or themes, for example, car, travel, swimming, beach, athletics, and ice cream. The user profile may define ad categories to allow, and/or ad categories to block.

As used herein, the term user preference is sometimes inclusive of the term user profile. The terms user preference and user profile are sometimes interchangeable.

User preferences and/or user profiles may be defined per client 202, per user of the client, and/or per user of multiple clients.

User preferences and/or user profiles may be collected per user and/or per client 202. Clients 202 may be remotely and/or geographically distributed.

The user provides explicit consent for any filtering of advertisements destined to his/her respective client.

Optionally, at 104, the received user preference and/or user profile is transmitted to network element 212 over network 202. Network element 212 may be a central server residing within network 202. Multiple user preferences and/or user profiles from multiple users of respective multiple clients 202 may be transmitted to a single (or several) network element(s) 212.

The user preferences and/or user profiles for respective users and/or clients may be stored, for example, within a user profile database 214B connected to and/or stored on network element 212.

Clients may select to view ads (all or selected ads) in exchange for a benefit, for example, a lower cellular tariff.

At 106, advertisements transmitted by ad server(s) 206 to client(s) 202 are filtered by network element 212 based on respective user preferences defined for each user and/or each client 202, for example, by a filtering module 214C. Filtering at the network level is performed based on provided explicit consent of the user.

Alternatively or additionally, network data other than ads may be filtered for blocking based on user preferences and/or the user profile, for example, sexual content and/or age sensitive content. As used herein, the term advertisements may sometimes be replaced with the term content, for example, when referring to selectively blocking of content based on user preference and/or user profile. Content may include, for example, website, videos, text, sounds, images, games and apps.

Optionally, blocking of advertisements is triggered by one or more blocking triggers upon detection of network related packets, for example, by a blocking trigger sub-module 214D of filtering module 214C. The network related packets may be detected based on network related data, for example, one or more of: prior data about hosts, network protocols, ports, and/or other network related information. The network related data may be analyzed to trigger blocking based on an association with advertisements, for example, based on black lists, white lists, prior knowledge of network protocols, prior knowledge of specific applications, a classifier, classifier chains, and/or other methods that may classify the network related data to determine ad related packets for blocking. Blocking classifiers that automatically classify packets as ad-related may include, for example, neural networks, support vector machines, and nearest neighbor classifiers. These classifiers may be trained in supervised and/or non supervised modes.

Optionally, network blocking is performed, for example, by a network blocking sub-module 214E of filtering module 214C. The network blocking module may receive trigger events as input from the trigger sub-module. The trigger events may trigger blocking of the network data.

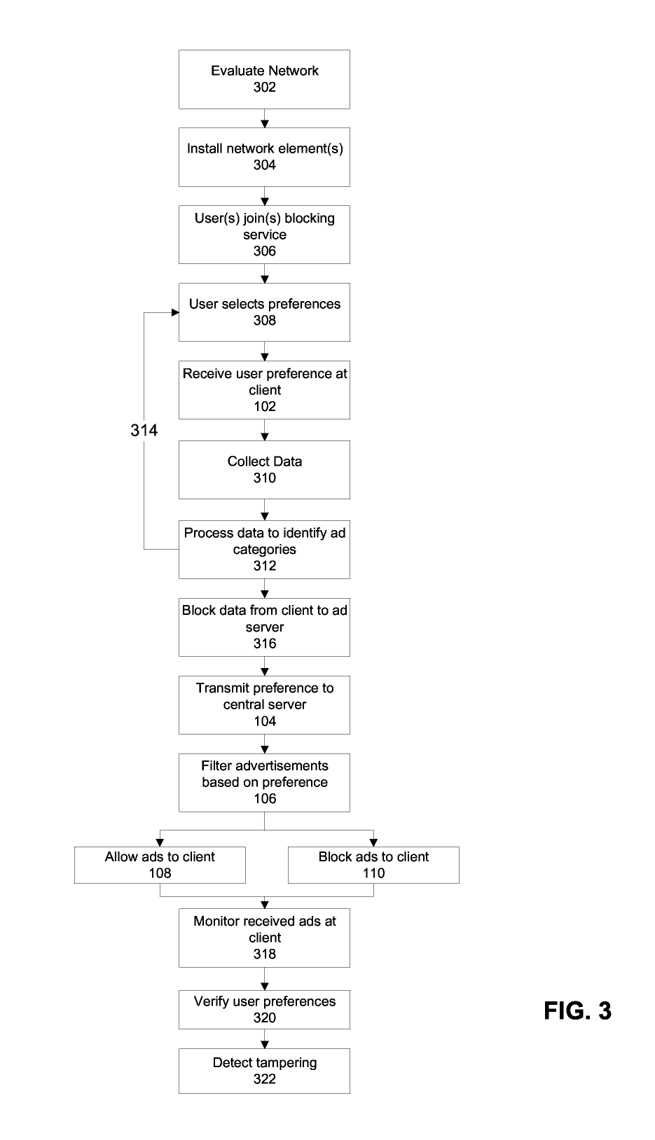

Data packets may be blocked in the ad server 206 to client 202 direction, and/or in the client 202 to ad server 206 direction (as described in detail with reference to block 316 of FIG. 3).

Blocking module 214E may be implemented within network element 212 (or other network connected device and/or server. In such architecture, undesired data is blocked at the network level, for example, at the cellular network, at the access network, at the transport network, or other selected network locations. Additional details about selecting the location for blocking is described with reference to block 302 and/or 304 of FIG. 3.

Optionally, at 108, advertisements are allowed to continue transmission to client(s) 202. The types of advertisements that are allowed to continue transmission may be defined by the user profile. Alternatively, all advertisements may be allowed, as may be defined by the user preference.

Alternatively or additionally, at 110, advertisements are blocked from transmission to client(s) 202. The types of advertisements that are blocked may be defined by the user profile. Alternatively, all advertisements may be blocked, as may be defined by the user preference.

Based on the user profile, some advertisements may be allowed and some advertisements may be blocked.

Reference is now made to FIG. 3, which is a detailed computer-implemented method based on the method of FIG. 1, including additional optional features, in accordance with some embodiments of the present invention. Blocks based on the method of FIG. 1 retain respective block numbering. Reference is also made to the system of FIG. 2. The method of FIG. 3 may be executed by the system of FIG. 2.

Optionally, at 302, the network is evaluated for implementation of the methods and/or systems described herein. For example, the network is evaluated for performance degradation due to advertisement traffic, reduction in revenue, reduction in bandwidth due to advertisement traffic, network bottlenecks caused by advertisement traffic, or other effects of advertisement traffic on the network. The system and/or methods described herein may be installed in network 202 when negative effects of advertisement traffic outweigh any potential benefits of such ad traffic.

Optionally, at 304, one or more network elements 212 are installed within network 202. Network element 212 may be a separate component connected to network 202, for example, a router with DPI capabilities, and/or network element 212 may be installed within existing network devices, such as software modules and/or a hardware card within an existing central server.

Optionally, the network element(s) 212 is selectively positioned within network 202 to increase performance within the network based on the blocking of the filtered advertisements, for example, to increase bandwidth, improve quality of service parameters, eliminate bottlenecks, or other network performance improvements.

Optionally, at 306, respective clients 202 and/or respective users join the service providing the ability to selectively filter advertisements. Users may select to filter advertisements based on performance of their mobile devices with wireless interface for wireless communication with network 202. For example, when clients have reduced battery life, users worry about harmful medical effects of excess radio signaling, and/or are paying excess costs for the advertisement packet transmission.

The filtering may reduce advertisement related radio signaling by the mobile device. Battery life may be improved when radio signaling is reduced. Users may worry less about harmful medical effects when they know that the radio signaling has been reduced. Users may not need to pay excess fees due to bandwidth taken up by unwanted ads.

Optionally, user interface module 210A is installed on client 202, for example, downloaded from network element 212 and/or another server. Other modules described herein providing related features for the advertising filtering service may be installed on client 202. Alternatively or additionally, the features provided by the modules are remotely provided through network 202, for example, by remotely accessing network element 212 and/or another server.

At 308, the user selects the user preference to allow or block ads. The user may select specific ad categories to allow and/or block as part of the user profile.

The user may manually select one or more categories from a list of categories, for example, by manually clicking on a pull down list of categories. The list of categories may be automatically generated based on data (for example, meta data) scanning of client 202, for example, as described in more detail in block 310 and/or block 312. Alternatively, the categories may be automatically selected, for example, based on the detected data.

Optionally, at 102, the user preference(s) and/or user profile(s) are received, as described with reference to FIG. 1.

Alternatively or additionally, the user may select to block other content, such as content of websites, for example, sexually offensive content, politically offensive content, and racially offensive content. The user may impose parental restrictions on the content by applying the content filtering.

Optionally, at 310, data is automatically collected at client 202 for generating the advertising categories that may be of interest to the user, for example, by a data collection module 210B. Data and/or meta data may be extracted from client 202. Exemplary data may be collected based on one or more of the following: applications that are installed on the client, usage patterns of the installed applications, geographical locations and/or travel patterns of the client, internet browsing history, and any other data and/or meta data that may provide a basis for automatic identification of ad categories.

The user may consent to provide the data, such as consent which specific types of data may be collected, and/or from where the data may be collected. The user may provide the consent through user interface 210A.

Features may be extracted from the user allowed data items. The extracted features may be varied and/or contain information from different modalities. The extracted features may contain static meta data regarding applications, for example: name, rating, and type. The extracted features may contain information, for example, regarding location, web searches and/or web browsing history. Other sources of information may come from various sensors on the device, such as geographical position from a global positioning sensor (GPS).

The extracted features may be placed in ordered buffers, to create feature vectors that may be used for classification.

Optionally, at 312, the collected data is processed to identify one or more ad categories, for example, by a data analysis module 210C. Optionally, the data is classified. Optionally, ad categories are aggregated. Module 210C may reside on client 202 and/or on a remote server, such as network element 212. When module 210C resides externally, the collected data may be transmitted to the external server for processing based on user consent.

The user profile may include the ad categories selected by the user to be blocked and/or to enable pass-through of the specific targeted ads associated with the category.

The list of ad categories may be automatically generated by one or more classifiers that deduce the interests of the user by sifting through the collected data.

The classifiers may be applied to the feature vectors of block 310 that were acquired from the feature extractor.

Classification may be based on one or more supervised learning methods, for example, neural networks, decision trees, support vector machines, or other suitable learning algorithm. Classification may be based on one or more unsupervised learning methods, for example, k nearest neighbor (KNN) clustering, Gaussian mixture model (GMM) parameterization, or other suitable learning methods.

The classifier(s) provide(s) a list of ad categories. The ad categories may be aggregated and presented to the user for selection.

For example, the system may deduce from location and/or motion information that the user leads an athletically active lifestyle. In addition, the user may have fitness related applications installed on his/her device. The system may then establish that the user may be interested in fitness and/or sports and add these to the topic lists.

In another example, a user installed applications related to gaming. Such apps may include gaming review websites or games for playing. The system may deduce from the time spent in the gaming applications that the user has an interest in games.

Games may be added to the advertisement category list. In yet another example, the user performs intra-device functions between his/her client and other devices. The system may detect an interest in gadgets as an ad category.

Such deductions may be based on any combination of machine learning algorithms and/or heuristics as described herein.

Optionally, at 314, the automatically identified ad categories are presented to the user on client 202, for example, displayed on a screen of client 202. The user may select and/or adjust the user profile based on the identified ad categories.

Optionally, at 316, data packets travelling from client 202 to ad server 206 are selectively filtered based on the user preference and/or user profile, for example, by a filtering module 210D. The filtered data packets may include, for example, polling signals transmitted by adware 208 to ad server 206, or malicious advertising related applications residing on client 202. Blocking of ad-related data packets may improve client 202 performance, for example, increasing battery life, reducing excess radio signals, and/or reducing user network usage costs.

Module 210D may be installed on client 202, and/or externally, for example, within network 202. Some clients 202 may not allow filtering and/or blocking operations to be performed, for example, based on restriction of the client and/or on privileges that are required for filtering applications. In such cases, filtering and/or blocking may be performed at selected locations within network 202. When module 210D is installed externally, the location for installation may be selected based on network performance affected by the packets from client 202, for example, within the access network serving client 202.

Alternatively or additionally, data packets are blocked by blocking module 214E on client 202. Blocking module 214E may perform blocking at the edge of network 202, and/or within network 202. Such an architecture may ensure that undesired information is not transmitted to network 202, such as beyond the operating system network stack and/or that advertisement related data is not moved on to the physical layer and/or to the cellular network.

At 104, the user preference(s) and/or user profile(s) is transmitted to network element 212, as described with reference to FIG. 1.

At 106, network element 212 filters ad related data packets from ad server 206, as described with reference to FIG. 1. Optionally, at 108, one or more ads are allowed to pass-through to client 202, as described with reference to FIG. 1.

Alternatively or additionally, at 110, one or more ads are blocked, as described with reference to FIG. 1.

Optionally, at 318, actual advertisements received at client 202 are detected and/or monitored, for example, by an ad detection module 210E. Alternatively or additionally, transmission of advertisement related data from client 202 to ad server 206 is monitored by ad detection module 210E.

Methods of detection of ads include, for example, detecting direct access to well known ad providers, sensing of virtual private network (VPN) connections, direct testing of local cache for known ad mechanisms, and testing of access to a synthetic ad provider that is part of the system infrastructure.

Optionally, at 320, verification is performed based on the defined user preferences and/or user profile, for example, by ad detection module 210E. The user experience of ad viewing as indicated by the user preferences and/or user profile is evaluated.

Optionally, the filtering being based on the user preference and/or user profile is evaluated and/or verified. The actual advertisements received at client 202 may be analyzed to determine that the correct advertisements have been allowed based on the user profile, and/or that the correct advertisements have been blocked based on the user profile.

Alternatively or additionally, performance at client 202 is evaluated based on the monitoring of outgoing advertisement related data. For example, verification that selected ad ware modules 208 have been turned off at client 202, and/or verification that the radio is not turned on excessively to transmit polling signals to ad server 206.

Optionally, at 322, device and/or network tampering is detected based on the monitoring and/or verification, for example, by a tamper detection module 210F that detects client tampering by unwanted ads (for example, unauthorized installation of adware modules) based on the monitoring of improperly received ads.

Device tampering is suspected when the user preference and/or user profile has not been met, for example, users that opted not to receive ads are receiving unwanted traffic. It may be assumed that no tampering has been performed on the client when the user preference and/or user profile has been verified, for example, users that opted to receive certain advertisements of certain categories are actually receiving ads only based on the user profile.

Anti tampering may include testing a proprietary test connection to the network filtering mechanism, for example, to network element 212. For example, detection of interception of HTTP/HTTPS/TCP/DNS, and/or verification of DNS results using a private DNS client. (Acronyms: HTTP=hypertext transfer protocol; HTTPS=HTTP secure; TCP=transmission control protocol; DNS=domain name system).

Upon suspecting and/or detecting tampering, adware modules may be searched and/or removed, for example, by module 210F. An event may be triggered to the network operator denoting that the advertisement blocking has either been tampered with (for example, by a malicious third party application), and/or that the effectiveness of the ad blocking has been degraded.

In some cases, unwanted advertisements may have been allowed to pass the filtering stage and presented to the user due to degradation of the ad blocking module for example, due to an error in classification. In such cases, the user may mark the ad as unwanted, signaling the error in classification (for example, by an on-screen button, by raising an electronic flag, and/or by deleting the message.). The error information may be transmitted to the central server, such as to network element 212. The classifier(s) may be retrained based on the corrected error.

Alternatively, tampering may be performed to block user desired ads. For example, module 210F senses that no ads are being shown to the user when the user has selected to receive ads, and/or that ads of certain user desired categories are not being shown. Such unwanted blocking may be due to the unauthorized installation of a 3rd party ad blocker, which may constitute a breach of the client's agreement with the network carrier. In such a case, an alert may be sent to the network operator, and/or blocking modules installed on client 202 may be removed.

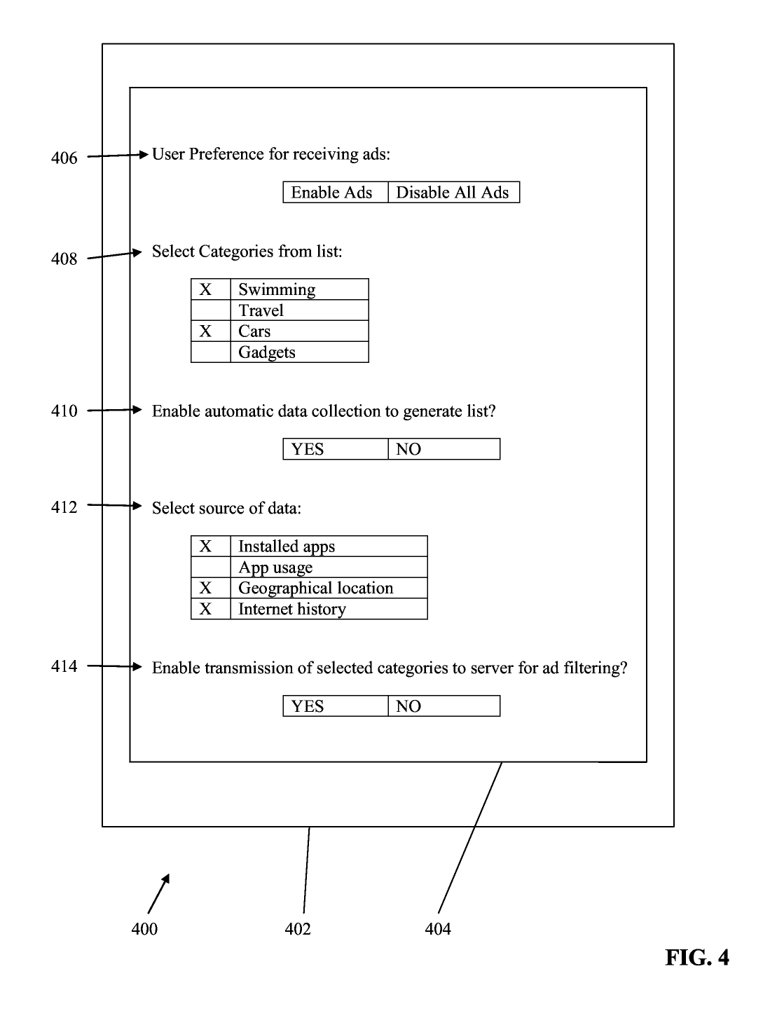

Reference is now made to FIG. 4, which is a schematic illustration of an exemplary user interface 400 for allowing a user of a client to control advertisement blocking at the network level, in accordance with some embodiments of the present invention. User interface 400 may be installed on client 202 (as described with reference to FIG. 2), such as a mobile device 402. User interface 400 is displayed on a screen 404 of the mobile device 402. User interface 400 may be stored on a memory of client 202, for example, as user interface module 210A (as described with reference to FIG. 2).

User interface 400 provides a clear, simple and/or explicit way to execute the method for getting the user consent for actions performed on mobile device 402 related to selective advertisement blocking as described herein, for example, with reference to FIGS. 1, 2 and/or 3. User interface 400 requests explicit consent for network filtering of advertisements, and/or for any data or meta data that is being written or read from mobile device 402, such as to generate the ad category topics as described herein.

It is noted that the user interface module may reside on a remote server, accessed by mobile device 402 through a network connection. It is also noted that non-mobile devices may allow the user access to user interface 400 and/or have the user interface module installed thereon, for example, desktop computers and/or a kiosk computer.

Optionally, user interface 400 includes a user preference definition 406, denoting whether to enable ads or globally block all advertisements.

When ads are globally disabled, no additional details may appear within user interface 400. When ads are enabled, user interface 400 allows the user to define particular ad categories for receipt and/or blocking, such as part of the user profile described herein.

A list of ad categories 408 may be displayed for selection by the user. For example, swimming, cars, beach vacation, restaurants, and games. The user may select the ad categories to allow and/or the ad categories to remove.

The list may be automatically created based on data collected from mobile device 402 to identify ad categories that may interest the user. User interface 400 may allow the user the option of automatically enabling data collection 410.

When the user selects to allow automatic data collection, user interface 400 may allow the user the option of selecting the sources of data 412 used to automatically build the topic selection lists, for example, the user may select one or more of: installed applications, usage pattern of applications, web browsing history, and geographical locations.

User interface 400 may require consent from the user to provide the list of selected ad topics to the filtering server 414 (e.g., network element 212 having filtering module 214C installed thereon as described with reference to FIG. 2). The list of topics may be transmitted to user profile database 214B as described with reference to FIG. 2.

User interface 400 may provide information to the user and/or allow the user to control other functions related to the advertisement blocking as described herein, for example, reporting on monitored performance of the filter, reporting on detected and/or removed adware, allowing the user to flag errors in received advertising types, and/or control over direction of blocking (from device to ad server and/or from ad server to device).

In one example, the user uses the user interface to enable the user preference to receive ads, for example, as described with reference to block 310 of FIG. 3. The user uses the user interface to enable automatic collection of data to identify ad topics.

The user selected all data sources available on the mobile client. The geographic location history data (for example, collected from a global positioning element connected to the mobile device), denotes that the user spends time near shores. Usage data of applications installed on the mobile device denotes an interest in fitness apps. Data of internet search history denotes an interest in swimming. The data is processed to determine ad categories that may be of interest to the user, for example, Sport and Swimming, for example, as described with reference to block 312 of FIG. 3. The Sport and Swimming categories are presented to the user via the user interface. The user selects one or both of the displayed categories, to allow ads corresponding to the selected categories. The displayed categories are arranged into a user profile. The user enables sending the user profile to the network element for selective blocking of ads that do not fall under the selected categories of the user profile.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant clients, networks, ad servers, and network elements will be developed and the scope of the terms clients, networks, ad servers and network elements are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method for filtering advertisements transmitted through a network to a client, comprising:
receiving at a client, from a user of the client, a user preference for filtering of advertisements for display on the client, the advertisements being transmitted over a network from an ad server to the client;
transmitting the user preference from the client to a network element located at an intermediate transmission location within the network between the ad server and the client; and
filtering the transmitted advertisements at the network element to block or allow advertisements to transmit to the client based on the user preference.

2. The method of claim 1, wherein the network element is selectively positioned within the network to increase bandwidth within the network based on the blocking of the filtered advertisements.

3. The method of claim 1, wherein the user preference comprises a user profile denoting at least one of advertisement categories to block and advertisement categories to allow.

4. The method of claim 1, wherein the filtering is performed based on deep packet inspection methods applied to packets transmitted to the client to identify the advertisements.

5. The method of claim 1, further comprising:
collecting data from the client;
processing the data to identify at least one advertisement category;
wherein receiving comprises receiving from the user at the client, a user profile denoting at least one of identified advertisement categories to block and identified advertisement categories to allow;
wherein filtering comprises filtering the advertisements to enable pass-through or block specific targeted ads associated with respective the at least one advertisement category based on the user profile.

6. The method of claim 5, wherein processing the data to identify at least one advertising category comprises applying at least one classifier to the collected data to automatically identify the at least one advertising category for blocking or allowing advertisements categorized under the at least one advertising category.

7. The method of claim 5, wherein the data comprises at least one member selected from a group consisting of: applications installed on the client, usage pattern of installed applications, geographical locations of the client, and internet browsing history.

8. The method of claim 1, wherein filtering comprises at least one of filtering advertisements transmitted from the ad server to the client, and filtering polling signals transmitted from advertising applications installed on the client to the ad server.

9. The method of claim 1, wherein filtering by the network element at the network level is performed with explicit consent of the user.

10. The method of claim 1, further comprising verifying the filtering is performed based on the user preference by monitoring actual advertisements received at the client relative to the user preference.

11. A system for filtering advertisements transmitted through a network to a client, comprising:
a user interface module for installation on a client, the user interface module programmed to receive from a user, a user preference for filtering of advertisements for display on the client, the advertisements being transmitted over a network from an ad server to the client; and
a network element located at an intermediate transmission location within the network between the ad server and the client, the network element programmed to receive the user preference from the client, and filter the transmitted advertisements based on the received user preference to block or allow the advertisements being transmitted to the client.

12. The system of claim 11, wherein the network element is selectively positioned within the network to increase bandwidth within the network based on the blocking of the filtered advertisements.

13. The system of claim 11, wherein the client is a mobile device having a wireless interface for wireless communication with the network, and the filtering reduces advertisement related radio signaling by the mobile device.

14. The system of claim 11, further comprising a data collection module for installation on the client, the data collection modules collects data denoting at least one user interest and transmits at least one of the collected data and the at least one user interest to the network element for filtering the advertisements based on the at least one user interest, to enable pass-through of specific targeted ads associated with the at least one user interest to the client.

15. The system of claim 11, wherein the user interface is programmed to comprise at least one member selected from a group consisting of: selection of whether to globally receive advertisements or not, selection of specific ad categories to block, selection of specific ad categories to allow, selection of data to be used to build automatic category selection lists, and selection of whether or not to allow transmission of the selected ad categories to the network element for targeted filtering.

16. The system of claim 11, further comprising a client filtering module for installation on the client, the client filtering module selectively blocking advertisement related traffic from the client to the ad server based on the user preference.

17. The system of claim 11, further comprising an ad detection module for installation on the client, the ad detection module monitors actual ads received by the client to verify that the filtering complies with the user preference.

18. The system of claim 17, further comprising a tamper detection module for installation on the client, the tamper detection module detects client or network tampering by unwanted ads based on monitoring of improperly received ads.

19. The system of claim 11, further comprising a data analysis module for installation on the client, the data analysis module automatically generates a category list based on data derived from the client for advertisement blocking or allowing.

20. A computerized method for filtering advertisements transmitted through a network to a client, comprising, comprising:
receiving a plurality of user preferences, each user preference received from each of a plurality of common users, the user preferences received through a plurality of user interfaces which are installed on a plurality of remote clients, each respective user preference denotes filtering of advertisements for display on the respective client, the advertisements being transmitted over a network from at least one ad server to each respective client;
transmitting the plurality of user preferences to at least one central server located at an intermediate transmission location within the network between the at least one ad server and each client; and
filtering each transmitted advertisement destined for each respective common user, at the central server, to block or allow each respective advertisement to each respective remote client based on respective user preference of each respective common user.
